(19) United States
(12) Patent Application Publication
(10) Pub. No.: US 2004/0056739 A1
(43) Pub. Date: Mar. 25, 2004

(54) Waveguide

(75) Inventors: Takayuki Inuzuka, Tokyo (JP); Muneaki Mukuda, Tokyo (JP); Naosi Yamada, Tokyo (JP); Hideki Asao, Tokyo (JP); Kazuhisa Henmi, Tokyo (JP); Kouji Yamasaki, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/427,932

(22) Filed: May 2, 2003

(30) Foreign Application Priority Data
Sep. 20, 2002 (JP) 2002-276839

(51) Int. Cl. H01P 3/12

(52) U.S. Cl. 333/239

(57) ABSTRACT

First and second members 1a, 1b, each having a U-shaped groove 20 of identical width and length, are joined together so as to constitute a waveguide channel while the U-shaped grooves 20 are opposed to each other. The first and second members 1a, 1b are fixedly fastened together by fastening bolts 2 and nuts 3 in the direction in which mating surfaces 5 are pressed together. Fastening force caused by the bolts 2 and the nuts 3 is depicted as circles 40 projected onto the mating surfaces 5 of the first and second members 1a, 1b. The bolts 2 and the nuts 3 are arranged such that lines of intersection (junction ridge lines) 6, each defined between a wall surface of the waveguide channel and the mating surface, are included in the respective projected circles 40.

### BACKGROUND OF THE INVENTION

1. Field of the Invention

The invention relates to a waveguide to be assembled with fastening members, such as nuts and bolts.

2. Related Art

A related-art waveguide has a groove-shaped member having an open surface side and joint pieces extending outwardly from both sides of the open surface side, and a plate-like member for closing the open surface side of the groove-shaped member. The joint pieces of the groove-shaped member and both sides of the plate-like member are fastened tightly together by means of locking members. Projections are formed at both angled portions in an opening section of the groove-shaped member. A recessed section having a depth smaller than the lengths of the projections is formed in the plate-like member. The projections and an interior surface of the recessed section are brought into hermetic contact with each other, thus constituting a double sealing structure (refer to, e.g., Patent Publication 1).

[Patent Publication 1]

JP-UM-A-5-11505 (pg. 4, FIG. 1)

However, at the time of fastening of this waveguide, angled portions of the projections facing a waveguide channel act as fulcrums, thereby causing deformation such that clearance arises in the sides of the projections facing a waveguide channel. As a result, there arises a problem of the impossibility of ensuring a dimensional accuracy and electrical sealing characteristic of a waveguide channel.

### SUMMARY OF THE INVENTION

The invention is conceived to solve the problem and aims at providing a waveguide which exhibits small deformation, caused by fastening, and which has a superior electrical sealing characteristic.

A first waveguide according to the invention comprises:

first and second members which when joined together constitute a waveguide channel;

fastening members for fixedly fastening the first and second members in a direction in which mating surfaces of the first and second members are pressed together, wherein

lines of intersection (junction ridge lines), each defined between a wall surface of the waveguide channel and the mating surface, are included in respective circles projected onto the mating surfaces by cones-of-influence of the fastening members.

A second waveguide according to the invention comprises:

a first member having an U-shaped groove;

a second member having an U-shaped groove, the groove being identical in width and length with that of the first member, a surface of the second member having the U-shaped groove being joined to the surface of the first member having the U-shaped groove; and

fastening members for fixedly fastening the first and second members in a direction in which mating surfaces of the first and second members are pressed together, the U-shaped groove of the first member and that of the second member constituting a waveguide channel, wherein

lines of intersection (junction ridge lines), each defined between a wall surface of the waveguide channel and the mating surface, are included in respective circles projected onto the mating surfaces by cones-of-influence of the fastening members.

### BRIEF DESCRIPTION OF THE DRAWINGS

FIGS. 1A and 1B are descriptive views of a waveguide according to a first embodiment of the invention;

FIG. 2 is a descriptive view of cones-of-influence projected on members to be fastened from fastening members according to the first embodiment;

FIGS. 3A and 3B are descriptive views of action of fastening members onto junction ridge lines when a plurality of fastening members are provided in the direction of propagation of a waveguide channel according to a second embodiment of the invention;

FIG. 4 is a longitudinal cross-sectional view of mating surfaces according to a third embodiment of the invention when taken along the direction of propagation of a waveguide channel; and

FIGS. 5A and 5B are descriptive views showing a waveguide shown for comparison.

### DETAILED DESCRIPTION OF THE PREFERRED EMBODIMENTS

(First Embodiment)

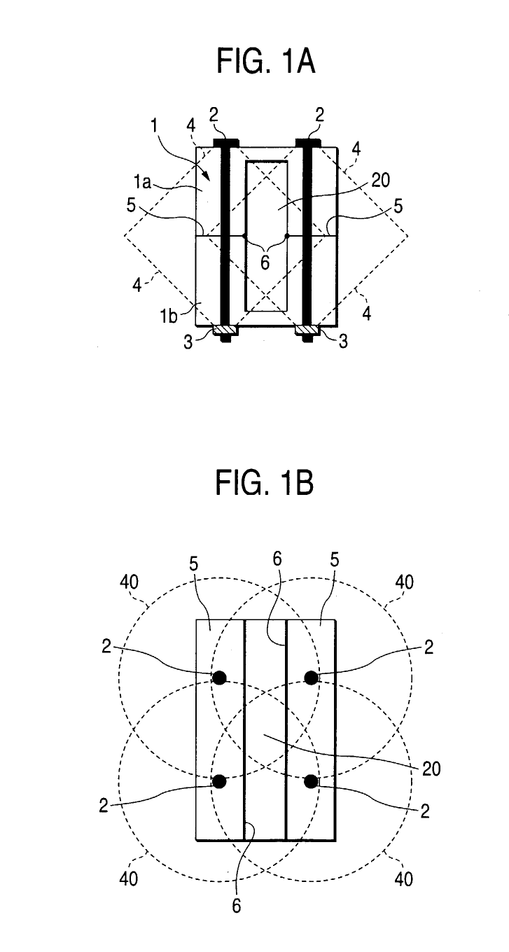

FIGS. 1A and 1B are descriptive views showing a waveguide according to a first embodiment of the invention. FIG. 1A is a lateral cross-sectional view of the waveguide, and FIG. 1B is a longitudinal cross-sectional view of the waveguide, showing a mating surface when viewed in the direction of propagation of a waveguide channel.

A waveguide 1 of the embodiment is of split type and can be split into a first member 1a and a second member 1b. The first member 1a and the second member 1b are joined together, thereby constituting a waveguide channel. The first and second members 1a and 1b are fixedly fastened with fastening members 2, 3 in the direction in which mating faces 5 of the first and second members 1a, 1b are pressed to each other.

In the embodiment, the fastening members 2, 3 must be provided such that lines of intersection (junction ridge lines) 6 defined between interior wall surfaces of the waveguide and the mating surfaces 5 are located within circles 40 projected on the mating surfaces 5 by cones-of-influence 4 caused by the fastening members 2, 3.

FIGS. 1A and 1B show that the first and second members 1a, 1b, each having a U-shaped groove 20 of fixed width and length, are joined together such that the U-shaped grooves 20 are opposed to each other. While taking the bolts 2 and the nuts 3 as fastening members, the first and second members 1a, 1b are fixedly fastened together in the direction in which the mating surfaces 5 of the first and second members 1a, 1b are pressed together. The U-shaped groove 20 of the first member and the U-shaped groove 20 of the second member constitute a waveguide channel.

Next will be described the cones-of-influence 4, which are indicated by broken lines in FIG. 1A and are ranges of action of fastening force exerted by the bolts 2 and the nuts 3.

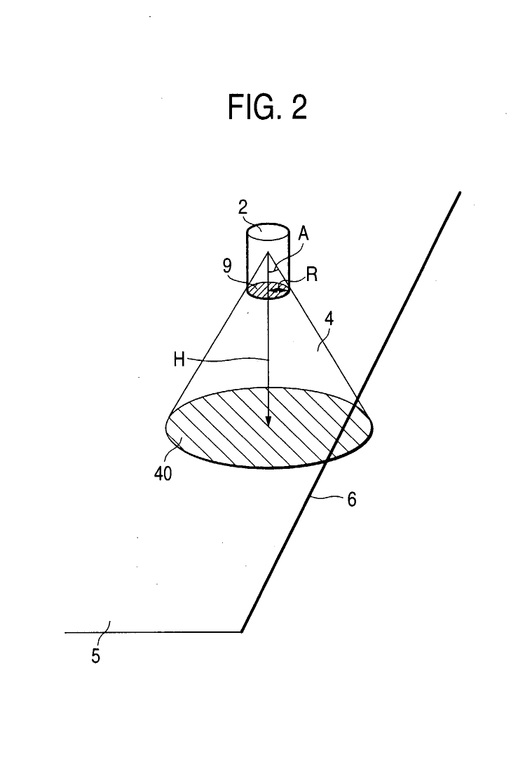

When members to be fastened (i.e., the first and second members of the embodiment) are fastened with standard fastening torque through use of fastening members, the resultant fastening force acts on the members to be fastened within the ranges of the cones shown in FIG. 2. The ranges are called “cones-of-influence.” FIG. 2 is a descriptive view of cones of influence imposed on the members to be fastened from the fastening members.

Specifically, the cone-of-influence 4 of a bearing surface 9 (having a radius R) of the bolt 2 corresponds to a cone having a half vertex angle A. Here, the half vertex angle A is a constant determined by the type of a member to be fastened. The drawing shows a case where the cone-of-influence is a cone having a half vertex angle of, e.g., 30°.

The bearing surface 9 of the bolt 2 and that of the nut 3 project the cones-of-influence 4 onto the mating surfaces 5 of the first and second members 1a, 1b, thereby defining circles (projected circles) 40.

As mentioned above, in the embodiment, in order to cause fastening force to act on the junction ridge lines 6, which are lines of intersection between the mating surfaces 5 and an interior wall of the waveguide, the bolts 2 and the nuts 3 are arranged such-that the junction ridge lines 6 are included in the ranges of the circles 40 projected from the cones-of-influence 4 onto the mating surfaces 5, in consideration of a range in which the fastening force acts on the inside of the first and second members of the waveguide.

More specifically, if the junction ridge lines 6 are included in the ranges of the projected circles 40, efficient action of fastening force can be achieved. Hence, the bolts 2 and the nuts 3 are arranged such that the fastening force acts on the junction ridge lines 6. As a result, the first and second members 1a, 1b can be brought into intimate contact with each other along the junction ridge lines 6. Consequently, the dimensional accuracy of the waveguide can be ensured.

The embodiment is described a case where the first and second members each assume U-shaped grooves. However, the invention is not limited to this embodiment. For instance, even when one of the first and second members assumes a plate-like shape, an advantage identical with that achieved in the embodiment can be yielded.

The first and second members may be formed from metal or resin. Particularly, in the case of resin which is inferior in rigidity to metal, the advantage yielded by the embodiment becomes prominent.

(Second Embodiment)

The following qualitative understanding is obtained in the first embodiment. Namely, in order to cause the junction ridge lines 6 defined between the mating surfaces 5 and the interior walls of the waveguide to be included in the circles-of-influence 40, the range of action of the fastening force is made wider by increasing a distance between the mating surface 5 and the bearing surface 9 of the bolt 2 or that of the nut 3. As a result, the waveguide 1 can be fastened through use of fewer bolts 2 and nuts 3.

As shown in FIG. 1B, it is qualitatively understood that, when the waveguide is fastened through use of a plurality of fastening members, the range of action of fastening force can become wider even if the distance between the fastening members is shortened.

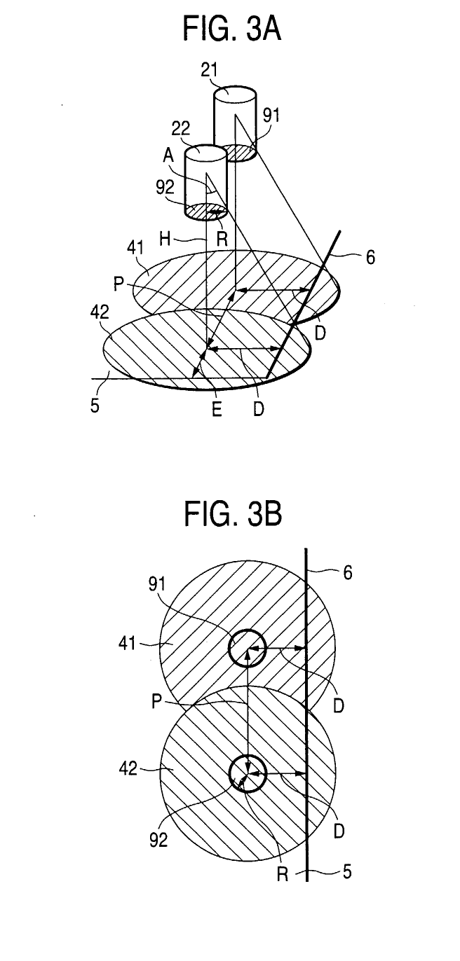

FIGS. 3A and 3B are descriptive views showing a case where a plurality of fastening members; that is, two fastening members 21 and 22, are provided in the direction of propagation of a waveguide channel; specifically, action of a first circle 41 on the junction ridge line 6, the first circle being projected on the mating surface 5 by a cone-of-influence of the first fastening member, and action of a second circle 42 on the junction ridge line 6, the second circle being projected on the mating surface 5 by a cone-of-influence of the second fastening member. FIG. 3A is a perspective view, and FIG. 3B is a plan view.

In order to cover the junction ridge line 6 with the first projected circle 41 and the second projected circle 42, the radius of the first projected circle 41 and that of the second projected circle 42 must be made larger than at least the shortest distance D between the center axis of the first fastening member 21 and the junction ridge line 6 and that between the center axis of the second fastening member 22 and the junction ridge line 6. To this end, the height H of bearing surfaces of the respective fastening members must satisfy the following Equation (1).

H>(D−R)/tan A (1)

In order to cover the junction ridge lines 6 with the first and second projected circles 41, 42, a pitch P between fastening members and the height H of bearing surfaces of the respective fastening member must satisfy the following Equation (2).

P≦2{(H×tan A+R)²−D²}^{1/2} (2)

This equation can be rewritten as

H≧{(4D²+P²)^{1/2}−2P}/(2−tan A) (2-1).

In order to more reliably attain intimate contact characteristic, the projected circles must cover distal ends of the respective junction ridge lines 6. For this reason, the height H of a bearing surface of each fastening member located at the distal end must satisfy the following equation (3).

As shown in FIGS. 3A and 3B, reference symbol E in the following equation (3) denotes the shortest distance between a longitudinally-end face of the waveguide and the center axis of each fastening member located at the distal end.

H≧{(D²+E²)^{1/2}−R}/tan A (3)

More specifically, fastening members must be arranged so as to satisfy Equations (1) and (2). In order to more reliably attain intimate contact characteristic, the fastening members are arranged so as to satisfy Equation (3).

Thus, there is yielded an advantage of the ability to efficiently fasten the junction ridge lines through use of fewer fastening members, thereby curtailing costs of fastening members as well as ensuring the dimensional accuracy of a waveguide channel.

For instance, as shown in FIGS. 3A and 3B, the first fastening member 21 having a bearing surface 91 of radius R and the second fastening member 22 having a bearing surface 92 of radius R are spaced apart from each other by a pitch P and are arranged such that the bearing surfaces 91, 92 are spaced from the corresponding mating surfaces 5 by a distance H. In this case, the junction ridge line 6 is covered with the first and second projected circles 41, 42 and without involvement of an excess or a deficiency (a point of intersection between the first and second projected circles 41, 42 becomes coincident with the junction ridge line 6), wherein the circles are projected on the mating surfaces 5 from the cones-of-influence. In this situation, the first and second fastening members 21, 22 are arranged such that the distance between the mating surfaces 5 and the first and second fastening members 21, 22 is made larger than H or such that the pitch becomes smaller than P, thereby causing the fastening force of the fastening members to act across the entire junction ridge line 6. During adjustment, the pitch between the fastening members 21, 22 is naturally set so as to become greater than a length of contact between the first fastening member 21 and the second fastening member 22.

In order to more reliably attain an intimate contact characteristic, the first and second projected circles 41, 42 must cover the distal ends of the junction ridge line 6.

(Third Embodiment)

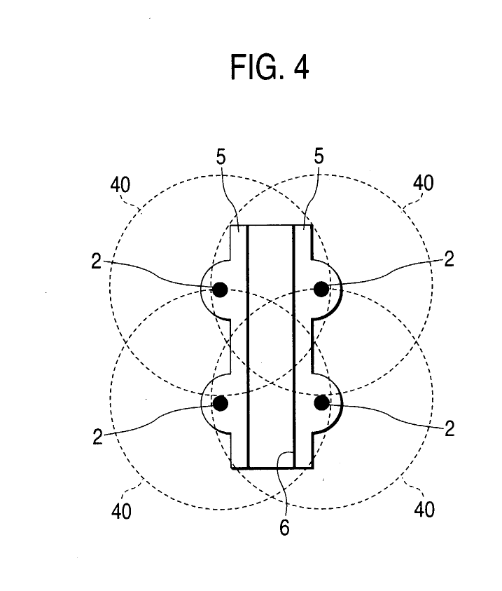

FIG. 4 is a longitudinal cross-sectional view of junction surfaces according to a third embodiment of the invention taken along the direction of propagation of a waveguide channel.

In the third embodiment, the waveguide of the embodiment is identical with that described in connection with the first embodiment, except that areas of outer side walls of the waveguide 1 other than those in which screw through sections are to be formed are trimmed, thereby enabling a reduction in the weight and cost of the waveguide 1.

In this case, the first and second members 1a, 1b must be located within areas that cover the junction ridge lines 6.

(Comparative Example 1)

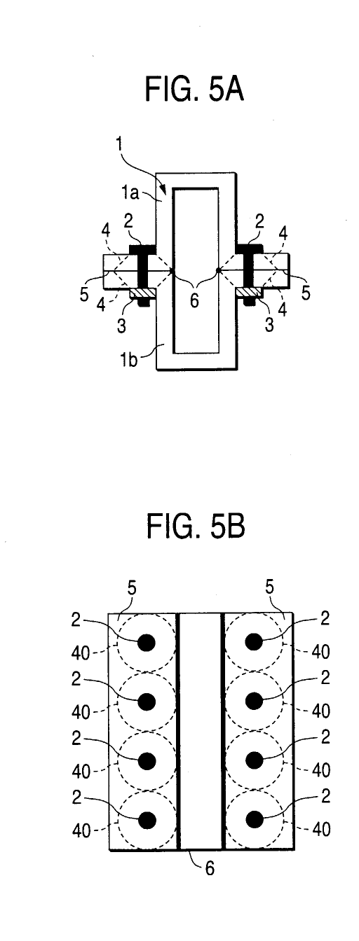

FIGS. 5A and 5B are descriptive views of a waveguide shown for comparison with the waveguide of the invention. FIG. 5A is a lateral cross-sectional view of a waveguide, and FIG. 5B is a longitudinal cross-sectional view of the waveguide, showing a mating surface when viewed in the direction of propagation of a waveguide channel.

Specifically, in consideration of the cones-of-influence 4 defined by the fastening members 2 described in connection with the first embodiment, if the projected circles 40 remain tangent to the junction ridge lines 6; namely, if the radii of the projected circles 40 are equal to the shortest distance D between the center axes of the fastening members 2 and the junction ridge lines 6, portions of the junction ridge lines 6 fail to be included in the projected circles 40. For this reason, fastening force of screws extends to only some of the junction ridge lines 6. This poses difficulty in attaining intimate contact between the first and second members 1a, 1b of the waveguide 1 along the junction ridge lines 6. Consequently, assurance of dimensional accuracy of the waveguide 1 becomes difficult.

More specifically, Equations (1), (2) fail to be satisfied simultaneously, and, hence, the radii of the projected circles 40 are made greater than the shortest distance D between the center axes of the fastening members 2 and the junction ridge lines 6. Further, adjustment must be performed so as to simultaneously satisfy Equations (1), (2) by making the distance H between the first-and second fastening members 21, 22 and the mating surfaces 5 greater than that shown in FIG. 3A or by making the pitch P between the first and second fastening members 21, 22 smaller.

In connection with the first through third embodiments, if protuberances are provided in the form of strips on the mating surfaces 5 of the first and second fastening members 21, 22 and along the junction ridge lines 6, points of action of fastening force are fixed to the protuberances at all times, thus efficiently causing the fastening force to act on the junction ridge lines 6.

The embodiments show that fastening members other than bolts or nuts, such as washers, are not used. However, in order to reduce looseness of fastening force of resin, use of washers, such as spring washers, is preferable.

### [EXAMPLES]

### First Example

A waveguide assuming the shape shown in FIGS. 1A and 1B comprises a top plate having a thickness of 2 mm; side plates, each having a thickness of 8.5 mm; and bolts whose center axes are spaced apart from the junction ridge line by a shortest distance of 3.7 mm and are spaced apart from longitudinal-end surfaces of a waveguide by a distance of 8.5 mm. After assembly, the waveguide constitutes a waveguide channel having a width of 5 mm, a height of 19 mm, and a length of 28 mm. First and second members which constitute the waveguide are formed from liquid-crystal polymer resin (Trade Name of Vectra C810, Polyplastics Co., Ltd.) through use of an injection molding machine (Trade Name of Model TH80E-9VE, Nissei Plastic Industrial Co., Ltd.) at a resin temperature of 320° C. and a molding temperature of 120° C.

The first and second members are plated with copper and fastened through use of M3 hexagonal bolts with holes and hexagonal nuts such that pressure-sensitive paper is nipped between the mating surfaces, thereby manufacturing a waveguide of the example.

Parameters required for Equations (1) through (3) described in connection with the embodiments are calculated as follows from the dimensions and shapes set forth. Namely, Height H of Bearing Surface of Bolt=(Height of Waveguide Channel/2)+Thickness of Top Plate=(19/2)+2=11.5 mm. Shortest Distance from Center Axis of Bolt to Junction Ridge Line=3.7 mm.

Radius R of Bolt Head=2.75 mm.

Pitch P between Fastening Members=Length of Waveguide Channel−(Distance between the Center Axis of Bolt to Longitudinal End Face of Waveguide×2)=28−8.5×2=11 mm.

In the example, a half apex angle of a cone-of-influence obtained at standard torque imposed on the liquid-crystal polymer serving as a member to be fastened is 45°. The waveguide of the example is verified to satisfy Equations (1), (2), and (3).

### Second Example

A waveguide assuming the shape shown in FIG. 4 comprises side plates having a thickness of 2 mm, each having substantially-semicylindrical sections to be used for inserting M3 hexagonal bolts with holes; a top plate having a thickness of 2 mm; and bolts whose center axes are spaced apart from the junction ridge line by a shortest distance of 3.75 mm and are spaced apart from longitudinal-end surfaces of a waveguide by a distance of 8.5 mm {corresponding to E of Equation (3)}. After assembly, the waveguide constitutes a waveguide channel having a width of 5 mm, a height of 19 mm, and a length of 28 mm. First and second members which constitute the waveguide are formed from liquid-crystal polymer resin (Trade Name of Vectra C810, Polyplastics Co., Ltd.) through use of an injection molding machine (Trade Name of TH80E-9VE, Nissei Plastic Industrial Co., Ltd.) at a resin temperature of 320° C. and a molding temperature of 120° C.

The first and second members are plated with copper and fastened through use of the M3 screws and the nuts such that pressure-sensitive paper is nipped between the mating surfaces, thereby manufacturing a waveguide of the example.

Parameters required for Equations (1) through (3) described in connection with the embodiments are calculated as follows from the dimensions and shapes set forth. Namely, Height H of Bearing Surface of Bolt=(Height of Waveguide Channel/2)+Thickness of Top Plate=(19/2)+2=11.5 mm. Shortest Distance from Center Axis of Bolt to Junction Ridge Line=3.75 mm.

Radius R of Bolt Head=2.75 mm.

Pitch P between Fastening Members=Length of Waveguide Channel−(Distance between the Center Axis of Bolt to Longitudinal End Face of Waveguide×2)=28−8.5×2=−11 mm.

In the example, a half apex angle of a cone-of-influence obtained at standard torque imposed on the liquid-crystal polymer serving as a member to be fastened is 45°. The waveguide of the example is verified to satisfy Equations (1), (2), and (3).

### Comparative Example 1

A waveguide assuming the shape shown in FIGS. 5A and 5B comprises a top plate having a thickness of 2 mm; side plates, each having a thickness of 2 mm; flanges, each having a thickness of 2 mm; bolts whose center axes are spaced apart from corresponding mating surfaces by a distance of 5.25 mm and are spaced apart from longitudinal-end surfaces of a waveguide by a distance of 5.25 mm {corresponding to E of Equation (3)}; and the center axes of the bolts being spaced apart from each other by a pitch of 10.5 mm (=P). After assembly, the waveguide constitutes a waveguide channel having a width of 5 mm, a height of 19 mm, and a length of 42 mm. First and second members which constitute the waveguide are formed from liquid-crystal polymer resin (Trade Name of Vectra C810, Polyplastics Co., Ltd.) through use of an injection molding machine (Trade Name of Model TH80E-9VE, Nissei Plastic Industrial Co., Ltd.) at a resin temperature of 320° C. and a molding temperature of 120° C.

The first and second members are plated with copper and fastened through use of the M3 hexagonal screws and nuts such that pressure-sensitive paper is nipped between the mating surfaces, thereby manufacturing a waveguide of the example.

Parameters required for Equations (1) through (3) described in connection with the embodiments are calculated as follows from the dimensions and shapes set forth. Namely, Height H of Bearing Surface of Bolt=(Height of Waveguide Channel/2)+Thickness of Top Plate=(19/2)+2=11.5 mm. Shortest Distance from Center Axis of Bolt to Junction Ridge Line=5.25 mm.

Radius R of Bolt Head=2.75 mm.

In the example, a half apex angle of a cone-of-influence obtained at standard torque imposed on the liquid-crystal polymer serving as a member to be fastened is 45°. The waveguide of the example is verified to fail to satisfy Equations (1), (2), and (3).

The waveguides manufactured in the first and second examples and that manufactured in comparative example 1 are disassembled. The waveguides are evaluated through use of pressure-sensitive paper which changes in color in accordance with pressure applied when nipped between the mating surfaces. Fastening force is found to be imposed across the mating surfaces of the waveguides of the first and second examples. In contrast, the fastening force is found to be imposed across only portions of the mating surfaces of the waveguide of comparative example 1.

A first waveguide of the invention is characterized by comprising first and second members which when joined together constitute a waveguide channel; and fastening members for fixedly fastening together the first and second members in the direction in which mating surfaces of the first and second members are pressed together. Lines of intersection (junction ridge lines), each line being defined between a wall surface of a waveguide channel and the mating surface, are included in circles projected on the mating surfaces by cones-of-influence of the fastening members. Accordingly, the first waveguide yields an advantage of exhibiting smaller deformation, caused by fastening, and a superior electrical sealing characteristic.

A second waveguide of the invention is characterized by comprising a first member having an U-shaped groove; a second member having a U-shaped groove identical in width and length with the U-shaped groove of the first member, the U-grooved surface being bonded to the U-grooved surface of the first member; and fastening members for fixedly fastening together the first and second members in the direction in which mating surfaces of the first and second members are pressed together. The U-shaped groove of the first member and that of the second member constitute a waveguide channel. Lines of intersection (junction ridge lines), each line being defined between a wall surface of the waveguide channel and the mating surface, are included in circles projected on the mating surfaces by cones-of-influence of the fastening members. Accordingly, the first waveguide yields an advantage of exhibiting smaller deformation, caused by fastening, and a superior electrical sealing characteristic.

What is claimed is:

1. A waveguide comprising:
first and second members which constitute a waveguide channel by joining together;
fastening members for fixedly fastening said first and second members in a direction in which mating surfaces of said first and second members are pressed together, wherein
lines of intersection (junction ridge lines), each defined between a wall surface of the waveguide channel and the mating surface, are included in respective circles projected onto the mating surfaces by cones-of-influence of said fastening members.

2. A waveguide comprising:
a first member having a U-shaped groove;
a second member having a U-shaped groove, the groove being identical in width and length with a length of said first member, a surface of said second member having the U-shaped groove being joined to the surface of said first member having the U-shaped groove; and
fastening members for fixedly fastening said first and second members in a direction in which mating surfaces of said first and second members are pressed together, the U-shaped groove of said first member and the U-shaped groove of said second member constituting a waveguide channel, wherein
lines of intersection (junction ridge lines), each defined between a wall surface of the waveguide channel and the mating surface, are included in respective circles projected onto the mating surfaces by cones-of-influence of said fastening members.

3. The waveguide according to claim 1, further comprising:
first and second fastening members provided in the direction of propagation of a waveguide channel, wherein
a distance between said first and second fastening members is set so as to become equal to or less than a distance which is achieved when a point of intersection between a first circle projected onto the mating surface by a cone-of-influence of said first fastening member and a second circle projected onto the mating surface by a cone-of-influence of said second fastening member comes to a junction ridge line, and so as to become greater than a distance obtained when said first and second fastening members come into contact with each other.

4. The waveguide according to claim 1, further comprising:
first and second fastening members provided in the direction of propagation of the waveguide channel, wherein
a distance between said first and second fastening members and corresponding mating surfaces is set so as to become greater than a distance which is achieved when a point of intersection between a first circle projected onto the mating surface by a cone-of-influence of said first fastening member and a second circle projected onto the mating surface by a cone-of-influence of said second fastening member comes to a junction ridge line.

5. The waveguide according to claim 1, wherein
protuberances are provided in the form of strips along the waveguide channel on at least one of the mating surface of said first member and the mating surface of said second member.

6. The waveguide according to claim 2, further comprising:
first and second fastening members provided in the direction of propagation of a waveguide channel, wherein
a distance between said first and second fastening members is set so as to become equal to or less than a distance which is achieved when a point of intersection between a first circle projected onto the mating surface by a cone-of-influence of said first fastening member and a second circle projected onto the mating surface by a cone-of-influence of said second fastening member comes to a junction ridge line, and so as to become greater than a distance obtained when said first and second fastening members come into contact with each other.

7. The waveguide according to claim 2, further comprising:
first and second fastening members provided in the direction of propagation of the waveguide channel, wherein
a distance between said first and second fastening members and corresponding mating surfaces is set so as to become greater than a distance which is achieved when a point of intersection between a first circle projected onto the mating surface by a cone-of-influence of said first fastening member and a second circle projected onto the mating surface by a cone-of-influence of said second fastening member comes to a junction ridge line.

8. The waveguide according to claim 2, wherein
protuberances are provided in the form of strips along the waveguide channel on at least one of the mating surface of said first member and the mating surface of said second member.
